(19) United States
(12) Patent Application Publication
(10) Pub. No.: US 2011/0125726 A1
(43) Pub. Date: May 26, 2011

(54) SMART ALGORITHM FOR READING FROM CRAWL QUEUE

(75) Inventors: Mircea Neagovici-Negoescu, Bellevue, WA (US); Siddharth Rajendra Shah, Bothell, WA (US)

(73) Assignee: Microsoft Corporation, Redmond, WA (US)

(21) Appl. No.: 12/625,603

(22) Filed: Nov. 25, 2009

(51) Int. Cl. G06F 15/16; G06F 17/30

(52) U.S. Cl. 707/709; 709/226; 707/E17.108

(57) ABSTRACT

A smart algorithm for processing transaction from a crawl queue. If the crawler has in memory a predetermined number of URLs for a given host, the crawler reads from the crawl queue URLs from other hosts. As a result the crawler processes multiple hosts concurrently, and thus, uses machine resources more effectively and efficiently to process the URLs. The smart algorithm can further consider other criteria in deciding which URLs to read from the queue. These criteria can include the response time for each repository (host) the crawler processes. Additionally, the crawler can allocate its resources according to content groups (e.g., two pools), one group for faster content delivery and the second group one for slower content delivery. Thus, crawler resources can be partitioned or divided across different pools depending on repository response time. Other criteria can be provided and considered as well.

### BACKGROUND

During a crawl of repositories (hosts), the crawler uses a first-in-first-out (FIFO) queue to determine which URLs of the hosts to crawl. At any point in time, the crawler can be processing tens of thousands of URLs from this queue. Because the queue is read in FIFO order, the crawler can get into a state in which URLs from only one host are processed, since the same host occupies the largest number of URLs in the queue. In such situations, the resources on the crawler machine are not used at the maximum capacity because the crawler is processing a single host.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture provides a smart algorithm for reading from the crawl queue. If the crawler has in memory a predetermined number of URLs for a given host, the crawler reads from the crawl queue URLs from other hosts. As a result the crawler processes multiple hosts concurrently, and thus, uses machine resources more effectively and efficiently to process the URLs.

In a more robust embodiment, the smart algorithm further considers other factors or criteria in deciding which URLs to read from the queue. These criteria can include the response time for each repository (host) the crawler processes. By considering this criterion, for example, the crawler can manage its resource more effectively and efficiently, and prevent the processing of an excessive number of URLs that come from slow hosts. Additionally, the crawler can allocate its resources according to content groups (e.g., two pools), one group for faster content delivery and the second group one for slower content delivery. Thus, crawler resources can be partitioned or divided across different pools depending on repository response time. Other criteria can be provided and considered as well.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented crawler system in accordance with the disclosed architecture.

FIG. 2 illustrates a more detailed alternative embodiment of a crawler system.

FIG. 3 illustrates an alternative embodiment of a crawler system that further includes an analysis component.

FIG. 4 illustrates a computer-implemented crawler method in accordance with the disclosed architecture.

FIG. 5 illustrates additional aspects of the method of FIG. 4.

FIG. 6 illustrates a block diagram of a computing system operable to execute crawler resource management in accordance with the disclosed architecture.

### DETAILED DESCRIPTION

The disclosed architecture employs a smart crawler algorithm for reading from the crawl queue. If the crawler has in memory a predetermined number of transactions (e.g., uniform resource locators (URLs)) for a given host, the crawler reads from the crawl queue location information associated with other hosts. As a result the crawler processes multiple hosts in parallel and uses resources on the machine in an efficient manner to process these location information.

An extension of the ability of the crawler to read smarter from the queue is that the crawler can be aware of the response time for each host it crawls. By doing so, the crawler can manage crawler resource better, and thereby, never allow processing of too many transactions that come from slow hosts. Moreover, the crawler can partition the resources into pools, such as a first pool for faster data and a second pool for slower data.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

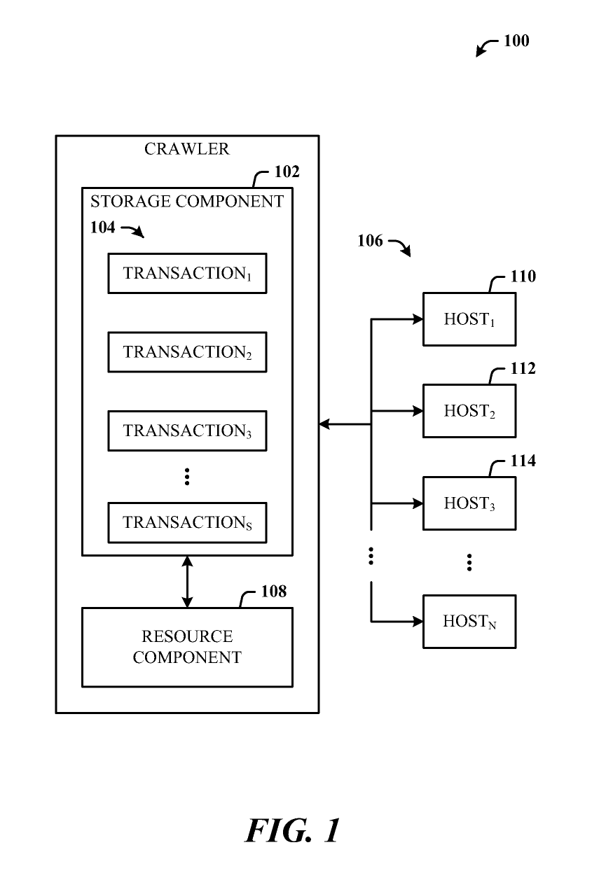

FIG. 1 illustrates a computer-implemented crawler system 100 in accordance with the disclosed architecture. The system 100 includes a storage component 102 for storing transactions 104 of multiple hosts 106 in a sequential order. The hosts 106 are to be crawled for data. The system 100 also includes a resource component 108 (e.g., a resource allocation algorithm) that selects and loads one or more of the transactions 104 from the storage component 102 for crawling a host (of the hosts 106) based on other transactions available in the storage component 102 for other hosts.

In other words, the crawler can have a large number of threads (e.g., 256), meaning the crawler can make a correspondingly large number of simultaneous requests to download items (transactions) to crawl. However, for a single hostname, the crawler can be throttled to using a lower number of simultaneous requests so that the website being crawled is not overburdened so as to significantly affect performance. In one implementation, to know what location information (URLs) (the transactions 104) to process, the crawler can read up to fifty thousand rows (entries stored in a sequential manner such as first-in first-out (FIFO) order) from the crawl queue (the storage component 102) and process the URLs within that batch of fifty thousand rows while maintaining the lower number of simultaneous requests per host. In typical deployment scenarios, the crawler crawls several thousand hosts at the same time.

In existing systems, the crawler loads URLs from the queue in a SQL (structured query language) table in natural order (e.g., FIFO). Because of this, the conventional crawler oftentimes processes items from only one host, even if transactions from other hosts are in the queue (e.g., SQL). This is problematic since processing transactions from multiple hosts is desired because more threads can be used, and therefore, computing resources on the crawler are never idle. This is also problematic when processing items (data) from a slow host, since the crawler does nothing but wait for the slow host to return the data. During this time the crawler can process documents (data) from other (slow or fast) hosts.

The solution is in the resource component 108 that includes a queue stored procedure (e.g., SQL stored proc) where transactions are loaded from the queue. In one implementation, the stored procedure will not load more than five thousand transactions for a host, if there are transactions from other hosts in the queue.

Consider that the crawl queue has two million URLs to process, and the order in the queue is two-hundred thousand each from ten hosts, Host A, B, C, . . . , J. In accordance with the disclosed architecture, the crawler reads only a predetermined number (e.g., five thousand) of URLs for each host from the queue, thereby simultaneously processing the ten hosts even though the first fifty thousand in the crawl queue are from Host A. This way, the crawler can use an optimum number of threads for each host, crawl all ten hosts, and use the computing resources on the crawler machine in an optimized way.

In addition, if the crawler (via the resource component 108) determines that a particular host is slower to respond than other hosts, the crawler can dynamically change the predetermined number to a lower value, thereby ensuring that the other hosts (other than the slow host) are not starved for computing resources and are processed concurrently despite the presence of the slow host in the queue.

For example, consider that a first host 110 has ten thousand transactions queued in the storage component 102, yet a second host 112 has one thousand transaction queued and a third host 114 has five thousand transactions queued. Accordingly, the resource component 108 limits transactions loaded for the first host 110 according to a predetermined value (e.g., three thousand) so as to not starve resources available for processing the other transactions stored in the storage component 102). A trigger to this algorithmic behavior can be a disproportionate number of transactions in the storage component 102 for the hosts 106 to be crawled. In other words, the transactions stored in the storage component 102 for the first host, for example, can exceed the predetermined value, in which case the resource component will enable allocation of resources (threads).

As previously indicated, the transactions 104 can include uniform resource locators (URLs) of the hosts 106. The resource component 108 selects the other transactions of the other hosts (e.g., second host 112 and third host 114) based on the transactions in crawler memory ready for processing against the host (e.g., the first host 110). The resource component 108 allocates resources of the crawler to different pools of the multiple hosts 106 for concurrent processing of the transactions. The allocation can be based on response time of the host. The resource component 108 allocates threads (e.g., where the threads are associated with CPU time, memory available, etc.) for processing the transactions for the host (e.g., the first host 110) and other hosts (e.g., second host 112 and third host 114). The resource component 108 dynamically re-allocates the resources among the hosts 106 based on changes in response time of the hosts 106.

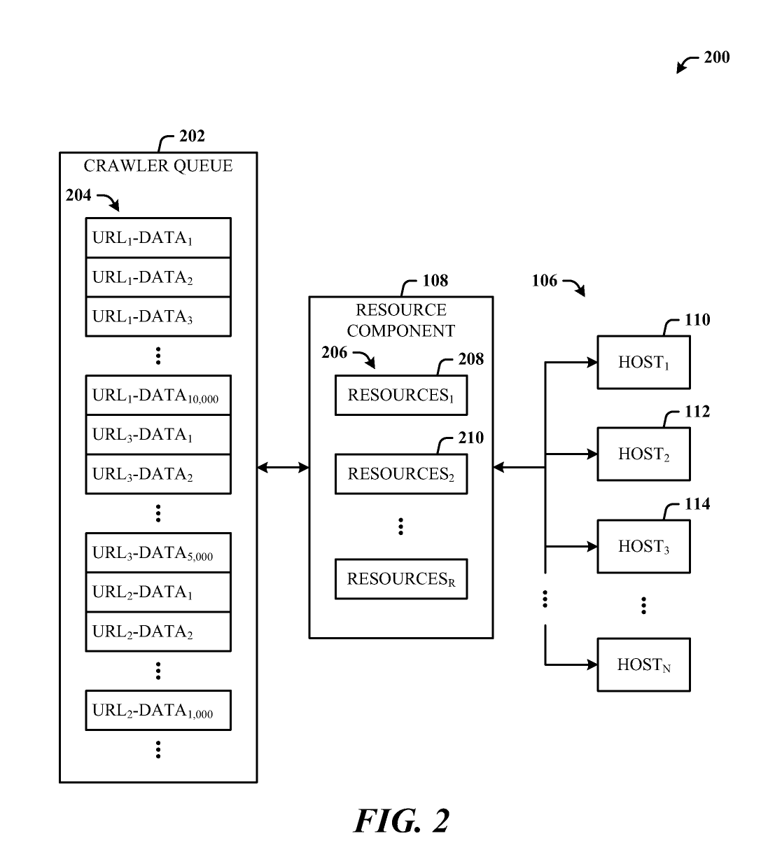

FIG. 2 illustrates a more detailed alternative embodiment of a crawler system 200. The system 200 includes a queue 202 for the storing location information 204 of the multiple hosts 106 in sequential order. The system 200 also includes the resource component 108 that selects and loads location information (e.g., URL₁-Data₁, . . . , URL₁-Data_{5,000}) from the queue 202 for a host (the first host 110) according to predetermined criteria (e.g., no more than 5,000 URLs processed for a host) based on other location information (e.g., URL₃-Data₁, . . . , URL₃-Data_{5,000} and URL₂-Data₁, . . . , URL₂-Data_{1,000}) available in the queue 202 for other hosts (the third host 114 and second host 112, respectively). The resource component 108 allocates crawler resources 206 (all the resources for the crawler machine) for concurrent processing of the location information 204 of the host and the other hosts.

The allocation of the resources 206 can be based on at least one of response time of the host to be crawled, complexity of the data to be crawled, or historical crawl information of the host to be crawled, for example. Other criteria can be imposed as well, such as the size and amount of the data to be crawled.

The resource component 108 can dynamically re-allocate the resources 206 among the host and the other hosts based on changes in capabilities of the host and other hosts. In other words, the resource component 108 can allocate a first subset 208 of the resources 206 to the first host 110, a second subset 210 of the resources 206 the second host 112, and so on.

Alternatively, the resource component 108 can allocate the resources 206 or subsets of the resources 206 to different pools (groups) of the hosts 106 for concurrent processing of the location information. For example, the first subset 208 of resources 206 can be allocated to the first host 110 and the second host 112, the second subset 210 allocated to the third host 114, and so on. The subsets of resources need not be the same size. In other words, in terms of percentages, the first subset 208 can include 70% of the total resources 206, since the first subset 208 is allocated to both the first host 110 and the second host 112. The second subset 210 can then be the remaining 30% of the resources 206 dedicated to the third host 114. Still alternatively, there can be resources that are not allocated, but held in reserve with the anticipation that these reserve resources will be allocated very soon to a known host to be crawled.

The resource component 108 can change a threshold of a criterion and re-allocate resources based on the changed criterion. For example, in the above example, the threshold (or predetermined criteria) is set to no more than five thousand transactions for a given host (e.g., the first host 110) will be processed at a time, and that the first and second resource subsets (208 and 210) are allocated to the first host 110. However, as the transactions are being processed, it can be that the resource component 108 senses a slowdown in the response time of the first host 110 due to any number of causes, such as host problems, connection problems, large amount of data, complex data, etc. Accordingly, the resource component 108 can automatically reduce the threshold to no more than three thousand transactions for the first host 110, or for all hosts 106. Thus, rather than maintain allocation of both the first and second resource subsets (208 and 210) to the first host 110, the resource component 108 can re-allocate the second subset 210 for other purposes, while maintaining allocation of the first subset 208 to the first host 110.

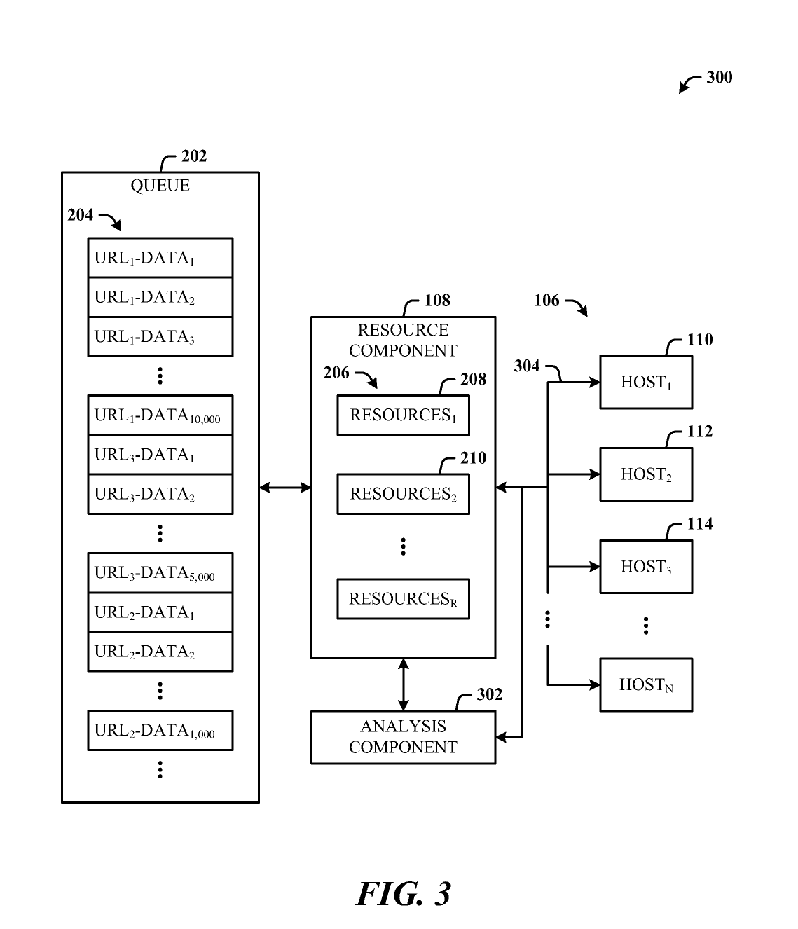

FIG. 3 illustrates an alternative embodiment of a crawler system 300 that further includes an analysis component 302. The analysis component 302 analyzes characteristics of the queue 202, resource component 108, network 304, and/or hosts 106 to derive patterns of activity, connection response and timing information, host and network limitations and capabilities, resource allocation for the hosts, etc., and create historical information and develops trends as to usage, for example. The results of this analysis can then be employed by the resource component 108 to allocate and re-allocate the resources 206 in an optimum way.

A goal is to not starve the resources 206. Accordingly, analysis can further result in reducing the number of transactions loaded for a slower host while increasing the transactions for a more responsive host.

Moreover, one criterion for enabling the resource algorithm can be interacting with a minimum number of hosts (e.g., three). This criterion can be fixed, or change dynamically based on loading factors. For example, if the default minimum number of hosts can be easily handled by the crawler resources 206, as determined by the analysis component 302 and conveyed to the resource component 108, the threshold criterion can be increased automatically until the resource component 108 operates at a higher level of allocated resources yet is performant for all purposes.

The criteria can include thresholds related to the number of content (data) items waiting in the queues from different hosts. For example, if Host A has fifty million items enqueued and Host B has ten items, it can be the case to simply process the Host B items and get it done immediately so as to dedicate more resources to Host A which many more items in the queue to process.

Alternatively, although Host B has only ten items, the quantity of data of the ten items is significantly greater than the quantity of data of the ten thousand items in Host A. Thus, it would take less time to process the ten thousand items than the ten items.

The analysis component 302 can analyze the pattern of responses from the host and basically dynamically read from the queue differently depending on how fast the particular host responds. This can be accomplished using a ping program or a traceroute program, for example, to determine how long it takes from the time the request is made to receive the response from the host and get all the data back. This information can then be stored in a way to obtain a weighted average against every host and then assign a weight, which is run in future transactions to decide how much content to read for that host from the queue 202. Historical information and trends can then be developed and applied to predict future trends.

The analysis component 302 can also analyze the complexity of the content (data) to be crawled from the host. Thus, it can be the case where the host is very fast, but the content it returns is extremely complex to process, and will take a lot of CPU power or memory power, etc., on the crawler side to process. In this situation, knowing that CPU usage will be excessive for this particular host and less for another host, the resources can be allocated to pull transactions in a way that balances the resources while processing.

It can be the case that multiple crawlers pull transaction from the same queue. Moreover, the crawlers can operate independently by marking what it has read, or can cooperate as well such as in an interleaving fashion. Still alternatively, when using multiple crawlers, each crawler can be dedicated to handling a specific host or set of hosts, and thus, each crawler only loads the corresponding transactions from the queue. A dedicated crawler can be realized if the host contains files of a type that require extra binaries to process, then a dedicated crawler can be beneficial.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

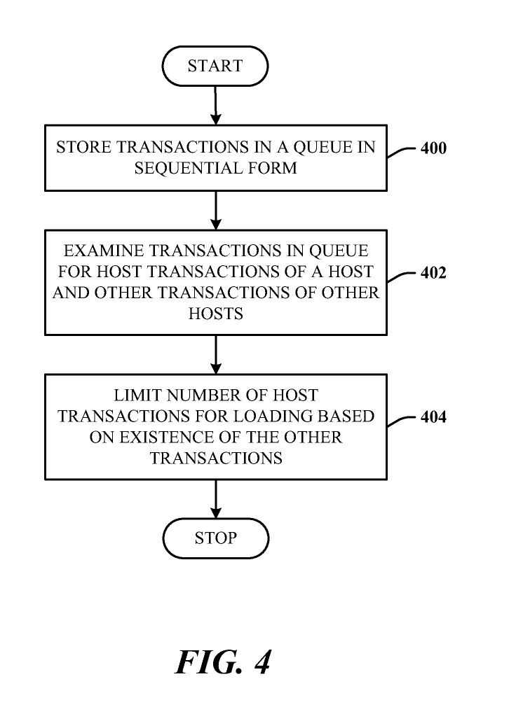

FIG. 4 illustrates a computer-implemented crawler method in accordance with the disclosed architecture. At 400, transactions are stored in a queue in sequential form. At 402, the transactions in the queue are examined for host transactions of a host and other transactions of other hosts. At 404, the number of host transactions for loading is limited based on existence of the other transactions.

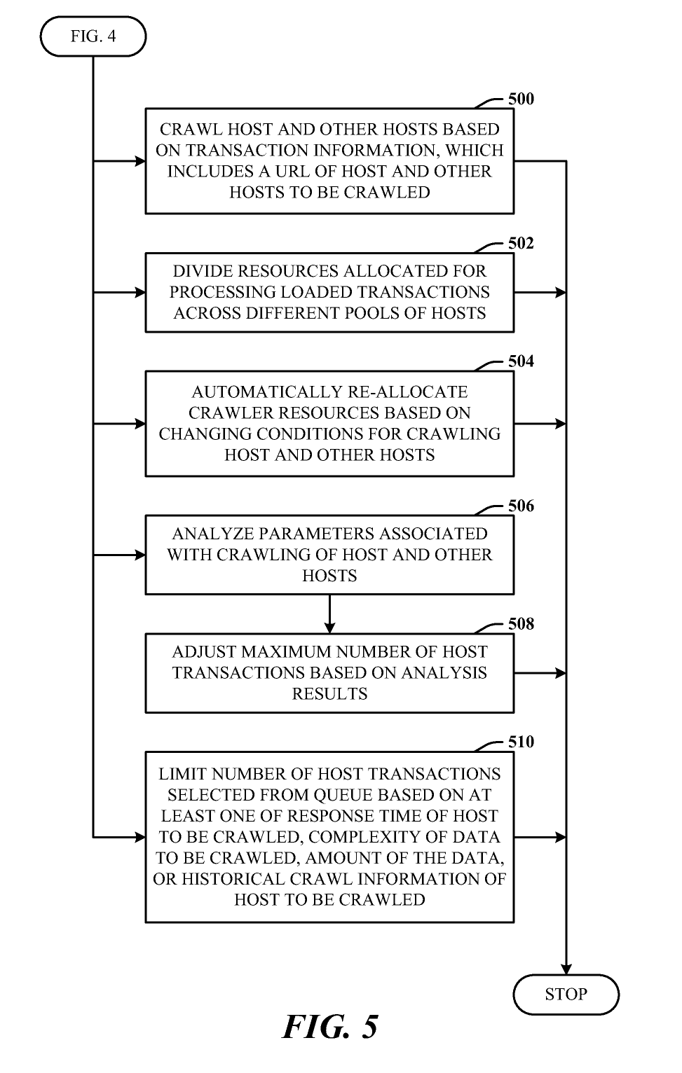

FIG. 5 illustrates additional aspects of the method of FIG. 4. At 500, the host and other hosts are crawled based on the transaction information, which includes a URL of the host and other hosts to be crawled. At 502, resources allocated for processing the loaded transactions are divided across different pools of hosts. At 504, crawler resources are automatically re-allocated based on changing conditions for crawling the host and the other hosts. The conditions can include response time of the host (e.g., a host processing slowdown/speedup, network slowdown/speedup, etc.). At 506, parameters associated with the crawling of the host and other hosts are analyzed. At 508, the maximum number of host transactions is adjusted based on analysis results. At 510, the number of host transactions selected from the queue is limited based on at least one of response time of the host to be crawled, complexity of the data to be crawled, amount of the data, or historical crawl information of the host to be crawled.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical, solid state, and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

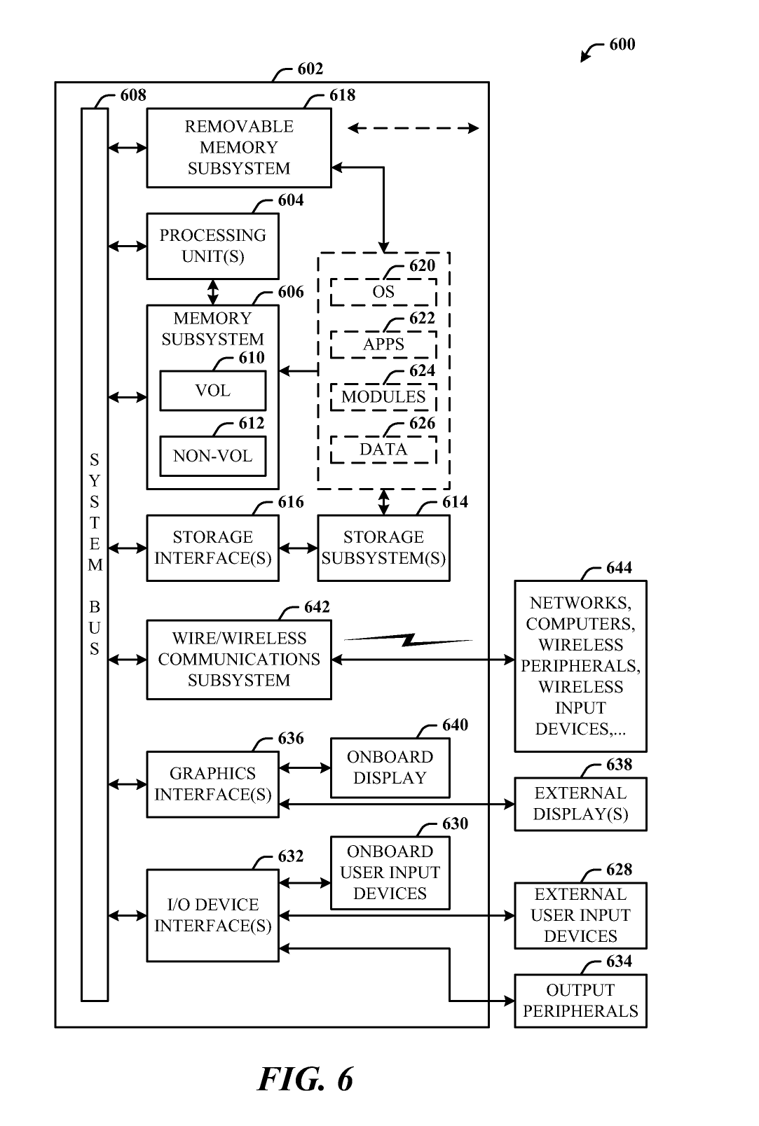

Referring now to FIG. 6, there is illustrated a block diagram of a computing system 600 operable to execute crawler resource management in accordance with the disclosed architecture. In order to provide additional context for various aspects thereof, FIG. 6 and the following description are intended to provide a brief, general description of the suitable computing system 600 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 600 for implementing various aspects includes the computer 602 having processing unit(s) 604, a computer-readable storage such as a system memory 606, and a system bus 608. The processing unit(s) 604 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 606 can include computer-readable storage such as a volatile (VOL) memory 610 (e.g., random access memory (RAM)) and non-volatile memory (NON-VOL) 612 (e.g., ROM, EPROM, EEPROM, etc.). A basic input/output system (BIOS) can be stored in the non-volatile memory 612, and includes the basic routines that facilitate the communication of data and signals between components within the computer 602, such as during startup. The volatile memory 610 can also include a high-speed RAM such as static RAM for caching data.

The system bus 608 provides an interface for system components including, but not limited to, the system memory 606 to the processing unit(s) 604. The system bus 608 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 602 further includes machine readable storage subsystem(s) 614 and storage interface(s) 616 for interfacing the storage subsystem(s) 614 to the system bus 608 and other desired computer components. The storage subsystem(s) 614 can include one or more of a hard disk drive (HDD), a magnetic floppy disk drive (FDD), and/or optical disk storage drive (e.g., a CD-ROM drive DVD drive), for example. The storage interface(s) 616 can include interface technologies such as EIDE, ATA, SATA, and IEEE 1394, for example.

One or more programs and data can be stored in the memory subsystem 606, a machine readable and removable memory subsystem 618 (e.g., flash drive form factor technology), and/or the storage subsystem(s) 614 (e.g., optical, magnetic, solid state), including an operating system 620, one or more application programs 622, other program modules 624, and program data 626.

The one or more application programs 622, other program modules 624, and program data 626 can include the crawler, storage component and resource component of the system 100 of FIG. 1, the crawler queue 202, location information 204, resource component 108 and resources 206 of the system 200 of FIG. 2, the additional analysis component 302 of the system 300 of FIG. 3, and the methods represented by the flow charts of FIG. 4-5, for example.

Generally, programs include routines, methods, data structures, other software components, etc., that perform particular tasks or implement particular abstract data types. All or portions of the operating system 620, applications 622, modules 624, and/or data 626 can also be cached in memory such as the volatile memory 610, for example. It is to be appreciated that the disclosed architecture can be implemented with various commercially available operating systems or combinations of operating systems (e.g., as virtual machines).

The storage subsystem(s) 614 and memory subsystems (606 and 618) serve as computer readable media for volatile and non-volatile storage of data, data structures, computer-executable instructions, and so forth. Computer readable media can be any available media that can be accessed by the computer 602 and includes volatile and non-volatile internal and/or external media that is removable or non-removable. For the computer 602, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 602, programs, and data using external user input devices 628 such as a keyboard and a mouse. Other external user input devices 628 can include a microphone, an IR (infrared) remote control, a joystick, a game pad, camera recognition systems, a stylus pen, touch screen, gesture systems (e.g., eye movement, head movement, etc.), and/or the like. The user can interact with the computer 602, programs, and data using onboard user input devices 630 such a touchpad, microphone, keyboard, etc., where the computer 602 is a portable computer, for example. These and other input devices are connected to the processing unit(s) 604 through input/output (I/O) device interface(s) 632 via the system bus 608, but can be connected by other interfaces such as a parallel port, IEEE 1394 serial port, a game port, a USB port, an IR interface, etc. The I/O device interface(s) 632 also facilitate the use of output peripherals 634 such as printers, audio devices, camera devices, and so on, such as a sound card and/or onboard audio processing capability.

One or more graphics interface(s) 636 (also commonly referred to as a graphics processing unit (GPU)) provide graphics and video signals between the computer 602 and external display(s) 638 (e.g., LCD, plasma) and/or onboard displays 640 (e.g., for portable computer). The graphics interface(s) 636 can also be manufactured as part of the computer system board.

The computer 602 can operate in a networked environment (e.g., IP-based) using logical connections via a wired/wireless communications subsystem 642 to one or more networks and/or other computers. The other computers can include workstations, servers, routers, personal computers, microprocessor-based entertainment appliances, peer devices or other common network nodes, and typically include many or all of the elements described relative to the computer 602. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 602 connects to the network via a wired/wireless communication subsystem 642 (e.g., a network interface adapter, onboard transceiver subsystem, etc.) to communicate with wired/wireless networks, wired/wireless printers, wired/wireless input devices 644, and so on. The computer 602 can include a modem or other means for establishing communications over the network. In a networked environment, programs and data relative to the computer 602 can be stored in the remote memory/storage device, as is associated with a distributed system. It will be appreciated that the network connections shown are exemplary and other means of establishing a communications link between the computers can be used.

The computer 602 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated aspects can also be practiced in distributed computing environments where certain tasks are performed by remote processing devices that are linked through a communications network. In a distributed computing environment, program modules can be located in local and/or remote storage and/or memory system.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented crawler system, comprising:
a storage component for storing transactions of multiple hosts in a sequential order, the hosts to be crawled for data; and
a resource component that selects and loads transactions from the storage component for crawling a host based on other transactions available in the storage component for other hosts.

2. The system of claim 1, wherein the resource component limits transactions loaded for the host according to a predetermined value when the other transactions are stored in the storage component.

3. The system of claim 2, wherein the transactions stored in the storage component for the host exceed the predetermined value.

4. The system of claim 1, wherein the transactions include uniform resource locators (URLs) of the hosts.

5. The system of claim 1, wherein the resource component selects the other transactions of the other hosts based on the transactions in crawler memory ready for processing against the host.

6. The system of claim 1, wherein the resource component allocates resources of the crawler to different pools of the multiple hosts for concurrent processing of the transactions.

7. The system of claim 6, wherein the allocation is based on response time of the host.

8. The system of claim 6, wherein the resource component allocates threads for processing the transactions for the host and other hosts.

9. The system of claim 6, wherein the resource component dynamically re-allocates the resources among the hosts based on changes in complexity of the data or quantity of the data.

10. A computer-implemented crawler system, comprising:
a queue for storing location information of multiple hosts in sequential order, the hosts to be crawled for data; and
a resource component that selects and loads location information from the queue for a host according to predetermined criteria based on other location information available in the queue for other hosts, the resource component allocates crawler resources for concurrent processing of the location information of the host and the other hosts.

11. The system of claim 10, wherein the allocation of resources is based on at least one of response time of the host to be crawled, complexity of the data to be crawled, amount of the data, or historical crawl information of the host to be crawled.

12. The system of claim 10, wherein the resource component dynamically re-allocates the resources among the host and the other hosts based on changes in capabilities of the host and other hosts.

13. The system of claim 10, wherein the resource component changes a threshold of a criterion and re-allocates the resources is based on the changed criterion.

14. The system of claim 10, further comprising an analysis component that analyzes characteristics of the queue and hosts, and sends analysis results to the resource component for allocating resources.

15. A computer-implemented crawler method, comprising:
storing transactions in a queue in sequential form;
examining the transactions in the queue for host transactions of a host and other transactions of other hosts;
imposing a maximum number of the host transactions for loading based on existence of the other transactions; and
processing the other transactions of the other hosts concurrently with the host transactions to prevent starving of resources allocated for crawling the host and other hosts.

16. The method of claim 15, further comprising crawling the host and other hosts based on the transaction information, which includes a URL of the host and other hosts to be crawled.

17. The method of claim 15, further comprising dividing resources allocated for processing the loaded transactions across different pools of hosts.

18. The method of claim 15, further comprising automatically re-allocating crawler resources based on changing conditions for crawling the host and the other hosts.

19. The method of claim 15, further comprising:
analyzing parameters associated with crawling of the host and other hosts; and
adjusting the maximum number of host transactions based on analysis results.

20. The method of claim 15, further comprising limiting the number of host transactions selected from the queue based on at least one of response time of the host to be crawled, complexity of the data to be crawled, amount of the data, or historical crawl information of the host to be crawled.
